(19) United States
(12) Patent Application Publication
(10) Pub. No.: US 2013/0327052 A1
(43) Pub. Date: Dec. 12, 2013

(54) EXHAUST SYSTEM FOR GAS TURBINES

(71) Applicant: GENALTA POWER INC., Calgary (CA)

(72) Inventors: Chris O'NEILL, Calgary (CA); Dobromir FILIP, Calgary (CA); Joseph KISS, Calgary (CA); Graham ILLINGWORTH, Calgary (CA)

(21) Appl. No.: 13/916,396

(22) Filed: Jun. 12, 2013

Related U.S. Application Data
(60) Provisional application No. 61/658,542, filed on Jun. 12, 2012.

(51) Int. Cl. F02C 6/18; F02C 7/141

(52) U.S. Cl. CPC F02C 6/18; F02C 7/141
USPC 60/772; 60/697; 60/690; 60/686

(57) ABSTRACT

An exhaust system is provided for mitigating condensate formation in a common exhaust stack and for effecting improved heat transfer. Reduced condensate formation and improved heat transfer is achieved by inducing non-laminar flow through the common exhaust stack and a heat exchanger operatively coupled to the common exhaust stack. Heat transfer is further improved by dew point control. Non-laminar flow is induced by connecting more than one gas turbine to the common exhaust stack through non-laminar flow inducing arrangements. The various coupling arrangements also add structural rigidity to the common exhaust stack for increased stack height and improved plume dispersion.

### CROSS REFERENCE TO RELATED APPLICATIONS

This application claims the benefits under 35 U.S.C 119(e) of U.S. Provisional Application Ser. No. 61/658,542, filed Jun. 12, 2012, which is incorporated fully herein by reference.

### FIELD

Embodiments described herein relate to an exhaust system for a plurality of gas turbines. More particularly, embodiments described herein relate to a method and system for mitigating condensate formation, effecting efficient recovery of heat from the exhaust gases and rendering a stable structural arrangement for a tall exhaust stack.

### BACKGROUND

Exhaust gases emitted from a gas turbine are typically vented or discharged to the atmosphere through an exhaust stack positioned on the gas turbine. The exhaust gases flow in a stream up the exhaust stack along the sidewall thereof and are pushed out of the exhaust stack by the pressure differential established across the gas turbine. The exhaust gases include a certain amount of moisture and other acidic pollutants such as SO₂ and H₂S that may condense when cooled.

The exhaust gases typically flow through the exhaust stack in a laminar pattern. Laminar flow is defined as fluid gliding through a channel (in this case the exhaust stack) in smooth layers, where the innermost layer flows at a higher rate than the outermost due to the effect of friction at the channel wall (in this case sidewall of the exhaust stack) interface. Laminar flow of the exhaust gases through the exhaust stack causes cool spots to be formed in the region along the sidewall of the exhaust stack. This results in condensation of the moisture and acidic pollutants contained in the exhaust gases along the exhaust stack sidewalls. Condensation slows down the flow of the exhaust gases through the exhaust stack. Condensate formation can also damage the exhaust system, shortening its life and increasing the frequency of maintenance.

Typically gas turbines are associated with a heat recovery/exchanger system for recovery of heat contained in the exhaust gases. The recovered heat can be converted into electrical power for powering or operating other devices. The heat contained in the exhaust gases may be recovered using systems based on Organic Rankine Cycle (ORC), heat pumps, or vane motors. Typically a heat exchanger has a plurality of heat pipes through which working fluid (coolant) flows. Heat from the exhaust gases flowing through the heat exchanger is transferred through the pipe wall to the working fluid. Applicant believes that since flow of exhaust gases through the gas turbine is laminar, flow of exhaust gases through the heat exchanger will also be laminar. Laminar flow develops an “insulating blanket” along the heat transfer region (along the pipe walls). The underlying physics of the blanket creation stems from the dynamic behaviour of molecules that participate in the heat transfer. As heat is transferred, the temperature of the gas molecules is lowered with a corresponding rise in surface (pipe wall) temperature. These cooler molecules insulate the surface from the higher temperature molecules further away from the surface, slowing convective heat transfer. This results in precipitate formation along the heat transfer region and inefficient heat transfer.

US Patent Application Publication No. 2012/0180485 to Smith et al. teaches an exhaust system that combines the exhaust gases from a plurality of gas turbines for increased heat recovery. US Patent Application Publication No. 2012/0180485 does not recognise issues related to condensate formation in the exhaust stack or in the heat exchanger nor does it provide a solution for addressing these issues.

Plume dispersion can be positively influenced by increasing the height of a conventional exhaust stack. However, height of the exhaust stack cannot be increased without compromising the structural integrity of the exhaust system.

Therefore, a need exists for an improved exhaust system that mitigates condensate formation in the exhaust stack, increases heat transfer efficiency and improves plume dispersion without compromising the structural integrity of the exhaust system.

### SUMMARY

Embodiments described herein relate to a system for mitigating condensate formation in the exhaust stack. Condensate formation is mitigated by inducing non-laminar flow such as turbulence to the exhaust gases flowing through the exhaust stack. Turbulence can be induced in a number of ways as described in the following description.

Embodiments described herein also relate to an improved and efficient heat transfer process. This is achieved through one or more of the aspects of inducing non-laminar flow and maintaining the temperature of the exhaust gases flowing through the exhaust stack above a threshold dew point. Dew point control can involve using an automated controller to continuously monitor the temperature, composition, and pressure of the flue gases (exhaust gases) to calculate the threshold dew point and using this information to control heat recovery from the exhaust gases. This kind of control introduces a layer of operation flexibility since the dew point can vary depending on the composition of the exhaust gases.

Embodiments described herein also relate to providing a tall exhaust stack for improved plume dispersion without compromising structural integrity of the exhaust system.

Accordingly in one broad aspect an exhaust system for a plurality of gas turbines is provided. The exhaust system comprises a common exhaust stack disposed in a generally vertical arrangement. An exhaust gas outlet positioned on each of the plurality of gas turbines is coupled to the common exhaust stack through a respective first flow-changing means for inducing non-laminar flow of exhaust gases through the common exhaust stack.

Accordingly in another broad aspect a method of recovering heat from exhaust gases flowing through a common exhaust stack receiving exhaust gases from a plurality of gas turbines connected thereto is provided. A heat exchanger is in the common exhaust stack. Non-laminar flow of exhaust gases is induced for flow through the common exhaust stack and the heat exchanger for minimizing formation of cool spots along a heat transfer interface. A threshold dew point is determined for exit of exhaust gases through the common exhaust stack. The exhaust gases are directed through the heat exchanger for recovery of heat from the exhaust gases along the heat transfer interface. The temperature at the heat exchanger is continuously monitored and heat recovery is reduced from the exhaust gases flowing through the heat exchanger when the temperature at the heat exchanger approaches the threshold dew point.

Accordingly in another broad aspect a method of recovering heat from exhaust gases flowing through a common exhaust stack receiving exhaust gases from a plurality of gas turbines connected thereto is provided. A heat exchanger is located in a heat exchanger conduit. The heat exchanger conduit is arranged in a parallel arrangement with the common exhaust stack. Non-laminar flow of exhaust gases is induced for flow through the common exhaust stack and the heat exchanger conduit for minimizing formation of cool spots along a heat transfer interface. A threshold dew point is determined for exit of exhaust gases through the common exhaust stack and/or the heat exchanger conduit. The exhaust gases are directed through the heat exchanger conduit for recovery of heat from the exhaust gases along the heat transfer interface. The temperature at the heat exchanger conduit is continuously monitored and flow of the exhaust gases through the common exhaust stack and the heat exchanger conduit is controlled in response to the temperature at the heat exchanger conduit. The threshold dew point can be continuously determined during an operation cycle.

Further, flow of exhaust gases through the common exhaust stack and the heat exchanger conduit is controlled by opening an access to the heat exchanger conduit when the temperature at the heat exchanger conduit is generously above the threshold dew point for passage of exhaust gases therethrough. An access to the common exhaust stack is opened and the access to the heat exchanger conduit is maintained open when the temperature at the heat exchanger conduit is above the threshold dew point. The access to the heat exchanger conduit is closed and the access to the common exhaust stack is maintained open when the temperature at the heat exchanger conduit approaches the threshold dew point.

### BRIEF DESCRIPTION OF THE DRAWINGS

FIG. 1 is a schematic illustrating one embodiment of an exhaust system, the schematic illustrating three gas turbines connected in a vertically offset arrangement to a common exhaust stack;

FIG. 2 is a schematic illustrating helical flow of exhaust gases through the common exhaust stack of FIG. 1;

FIG. 3 is a schematic illustrating offset arrangement of the exhaust gas outlets along the common exhaust stack of FIG. 1 for inducing non-laminar flow;

FIG. 4 is a schematic illustrating arrangement of flow-changing fins in the common exhaust stack of FIG. 1;

FIG. 5A is a schematic illustrating an additional embodiment of an exhaust system comprising a plurality of gas turbines connected to a common exhaust stack through three headers circumferentially distributed about the common exhaust stack;

FIG. 5B is a schematic illustrating turbulent flow of exhaust gases through the headers of FIG. 5A;

FIG. 6 is a schematic illustrating another embodiment of an exhaust system where a subset of the plurality of gas turbines is operatively coupled to a heat exchanger located in the common exhaust stack;

FIGS. 7A, 7B, 7C and 7D are schematics illustrating various arrangements for reducing heat extraction or recovery from exhaust gases flowing through the heat exchanger of FIG. 6, namely control of the flow of working fluid, control of residence time of exhaust gases, control of access to a bypass passage, and control of access to a housing, respectively;

FIG. 8 is a schematic illustrating another embodiment of an exhaust system, the exhaust system in this embodiment is operatively coupled to a heat exchanger arranged in a heat exchanger conduit parallel to the common exhaust stack; and

FIGS. 8A, 8B and 8C are schematics illustrating various arrangements for managing/controlling flow of exhaust gases through the common exhaust stack and the heat exchanger conduit of FIG. 8, namely a state where a valve in the common exhaust stack is open and a valve in the heat exchanger conduit is closed, a state where stack valve is closed and exchanger valve is open and a state where both valves are open, respectively.

### DESCRIPTION OF THE PREFERRED EMBODIMENTS

Embodiments described herein relate to an exhaust system which mitigates condensate formation in an exhaust stack by creating turbulence in exhaust gases flowing through the exhaust stack.

Embodiments described herein also relate an exhaust system and method for effecting improved heat transfer.

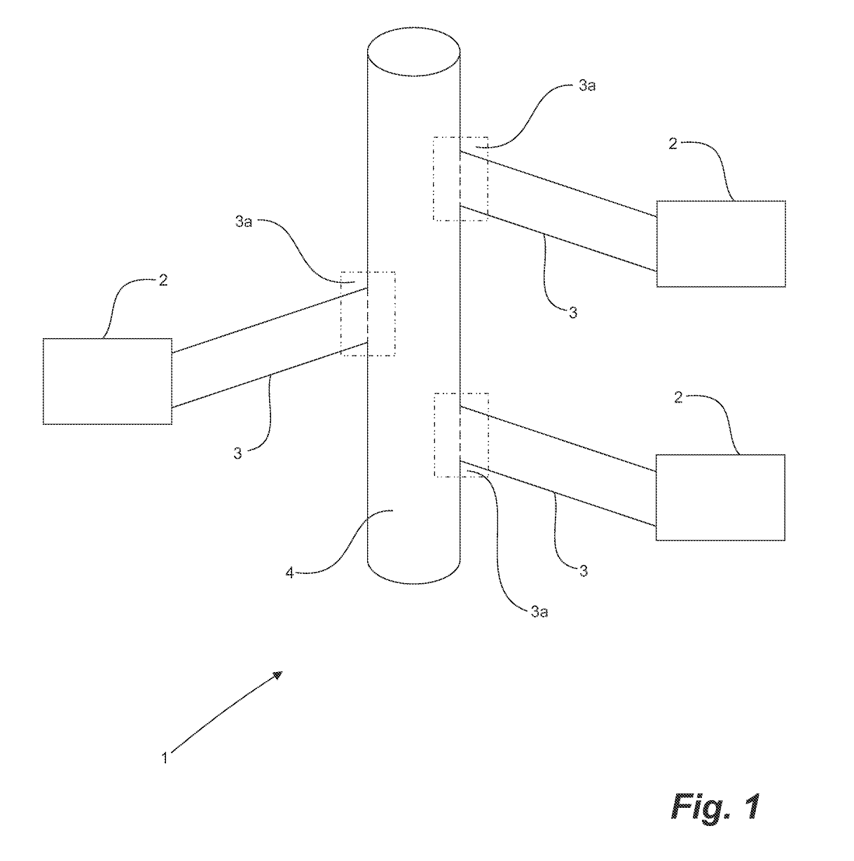

FIG. 1 shows arrangement of an exhaust system according to one embodiment. The exhaust system 1 comprises a plurality of gas turbines 2. Each gas turbine has an exhaust gas outlet 3 positioned thereon. The exhaust system 1 further comprises a common exhaust stack 4 disposed in a generally vertical arrangement. The common exhaust stack 4 is a conduit through which the exhaust gases are dispersed into the atmosphere. The exhaust gas outlet 3 (tubing 3) of each of the plurality of gas turbines 2 is coupled to the common exhaust stack 4 for discharging exhaust gas produced by the gas turbines 2 into the common exhaust stack 4. In conventional exhaust systems as described in US Patent Application Publication No. 2012/0180485, the exhaust gas outlets 3 feeding into the common exhaust stack 4 are substantially perpendicular to the common exhaust stack 4 which Applicant believes would produce a predominantly laminar flow of exhaust gases.

In the instant disclosure, the exhaust gas outlet 3 of each of the plurality of gas turbines 3 is coupled to the common exhaust stack 4 through a respective first flow-changing means 5. The first flow-changing means 5 minimizes any predisposition of the exhaust gases to flow in a laminar pattern and induces non-laminar flow of exhaust gases through the common exhaust stack 4.

In one embodiment, each of the first flow-changing means 5 is connected at an angle to the common exhaust stack 4.

In one embodiment, the first flow-changing means 5 is implemented by connecting a first set of exhaust gas outlet connectors or interconnects 3a at an angle to the common exhaust stack 4. The exhaust gas outlets 3 are connected or coupled to the common exhaust stack through the angled connectors 3a and form an angled connection with the common exhaust stack 4. The angled connection causes the gases flowing into the common exhaust stack 4 through the exhaust gas outlets 3 to rotate thereby changing the flow pattern of the exhaust gases to a non-laminar flow pattern. The non-laminar flow of the exhaust gases through the common exhaust stack 4 reduces the formation of cool spots along the sidewall of the common exhaust stack 4. This is in turn minimizes condensate formation. Further, to leverage the natural up draught of the hot exhaust gases and to reduce backflow into any gas turbine 2 which may be inactive, preferably, the exhaust gas outlets 3 are also angled upwards between the gas turbines 2 and the connectors 3a.

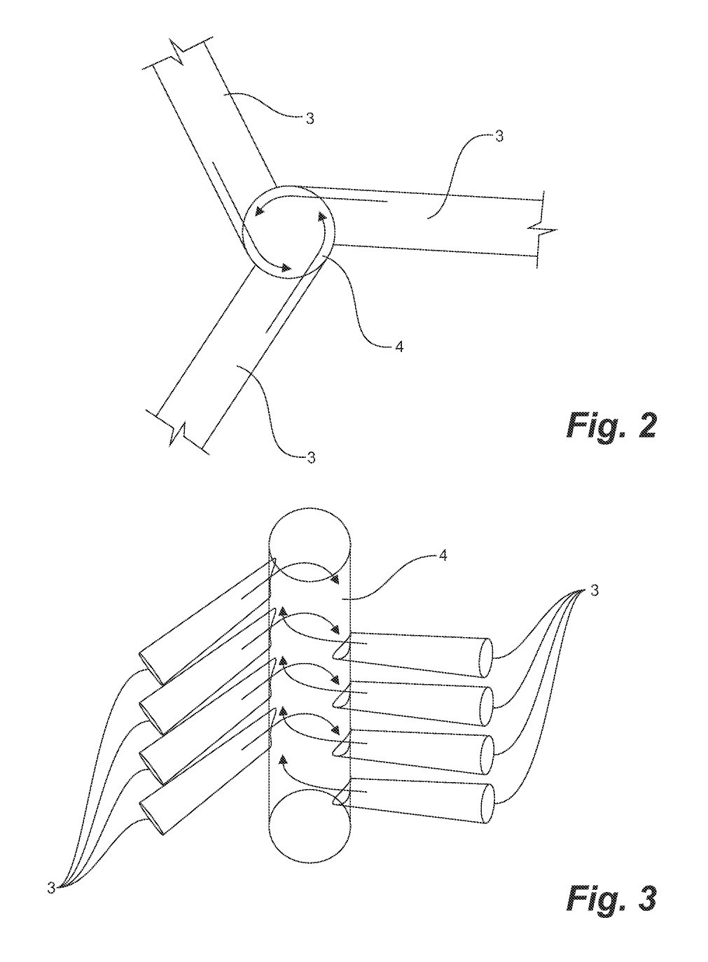

In one embodiment and with reference to FIG. 2, inducement of non-laminar flow of exhaust gases can be further enhanced by connecting the first flow-changing means 5 to the common exhaust stack 4 in a particular arrangement. In this arrangement, centerline of one first flow-changing means 5 and consequently centerline of one exhaust gas outlet 3 is offset from the centerline of another first flow-changing means 5 and consequently another exhaust gas outlet 3. Each first flow-changing means 5 is connected generally tangentially to the common exhaust stack 4. This arrangement causes swirling of the exhaust gases resulting in non-laminar flow of exhaust gases through the common exhaust stack 4.

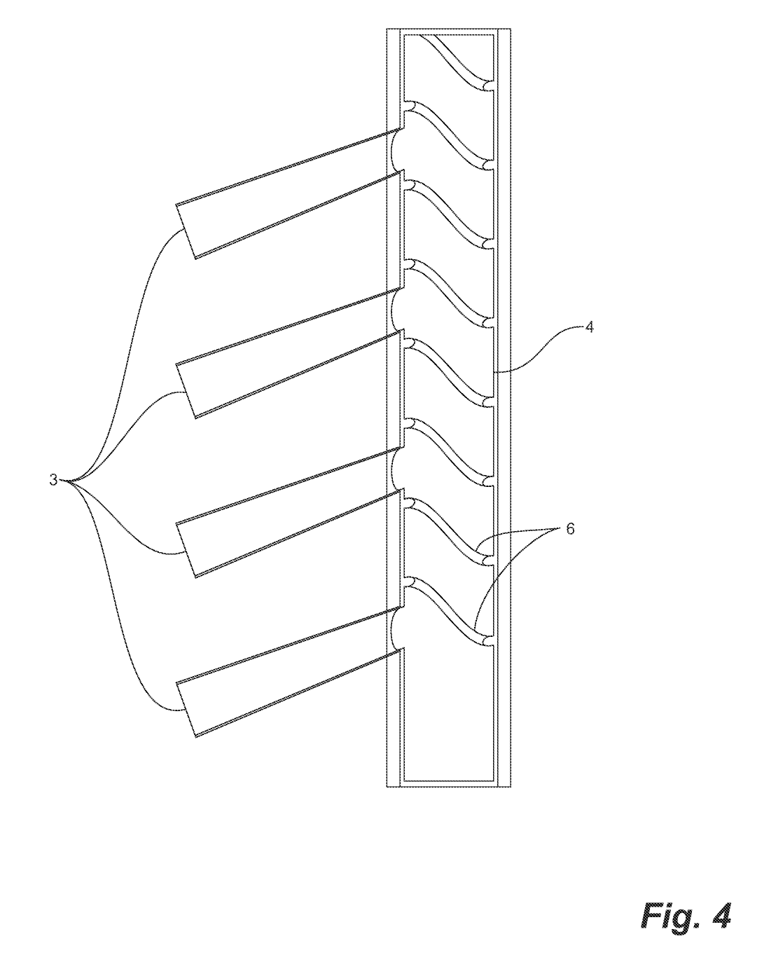

FIG. 3 illustrates another embodiment for enhancing inducement of non-laminar flow of exhaust gases through the common exhaust stack 4. In this arrangement, each first flow-changing means 5 is vertically offset from another first flow-changing means 5 along the common exhaust stack 4. The offset arrangement enhances mixing of the exhaust gases, flowing through the common exhaust stack 4, thereby minimizing the formation of cool spots and thereby minimizing condensates in the common exhaust stack 4.

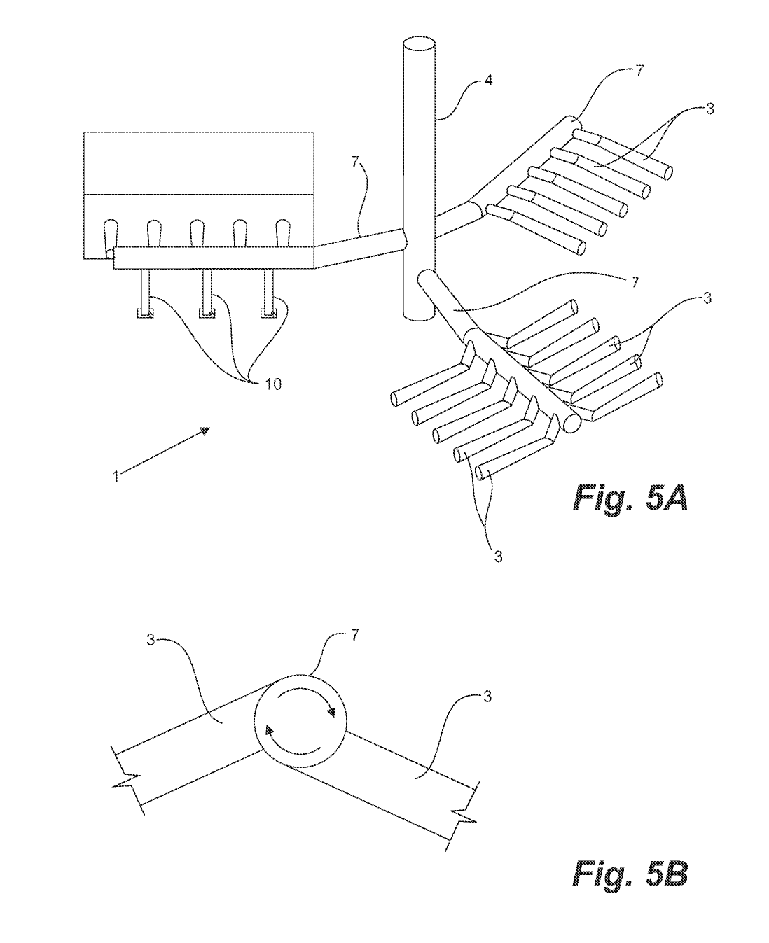

In another embodiment and with reference to FIG. 4, inducement of non-laminar flow of exhaust gases through the common exhaust stack 4 can be further enhanced by providing first elements 6 in the flow path of the exhaust gases. The first elements 6 may be disposed at about the first flow-changing means 5. In one embodiment, the first elements 6 may be disposed around an interface where the exhaust outlet 3 is connected to the common exhaust stack 4. In another embodiment, the first elements 6 may be disposed in the common exhaust stack 4.

The first elements 6 introduce local disturbances which further enhance mixing of the exhaust gases flowing along the first elements 6. The first elements 6 further aid in elimination of cool spots being formed in the common exhaust stack 4. Preferably, the first elements 6 are a plurality of fins located in the common exhaust stack 4. Local disturbances in the flow path can also be introduced by treating the internal surface of the common exhaust stack 4 and/or exhaust gas outlet 3. Internal surface treatment may include introducing surface corrugations or surface roughness.

Turbulence in the exhaust gases flowing through the common exhaust stack 4 can be enhanced by vertically offsetting the first flow-changing means 5 along the common exhaust stack 4, by offsetting the centerlines of the first flow-changing means 5 or by providing local disturbances in the flow path of the exhaust gases or a combination of the various arrangements illustrated in FIGS. 2, 3 and 4.

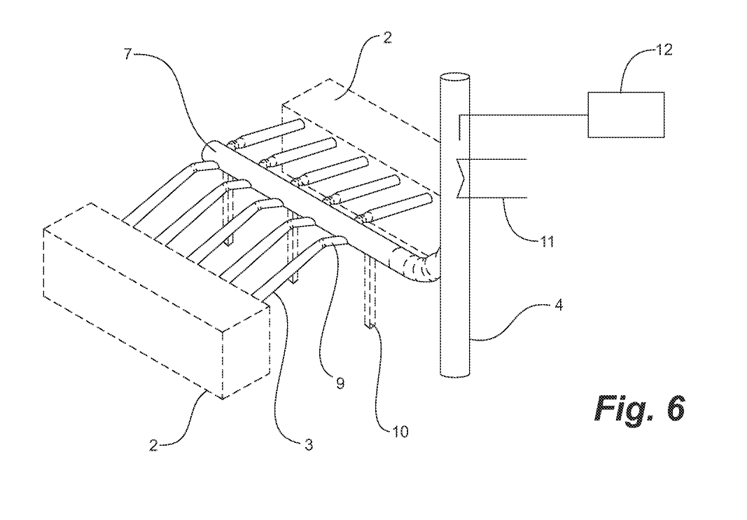

FIG. 5A shows a second embodiment of the exhaust system. The exhaust system of FIG. 5A is identical to the exhaust system of FIG. 1 except for the coupling arrangement between the exhaust gas outlets 3 and the common exhaust stack 4. In this embodiment, coupling of the exhaust gas outlets 3 to the common exhaust stack 4 is through a header 7. The exhaust gas outlets 3 are coupled to the header 7 through second flow-changing means 8. The second flow-changing means 8 performs the same function as the first flow-changing means 5, specifically to induce non-laminar flow of exhaust gases through the header 7. The second flow-changing means 8 changes the laminar flow pattern of the exhaust gases flowing through the header 7 to a non-laminar flow pattern.

In one embodiment, the exhaust system 1 comprises at least one header 7 and at least two exhaust gas outlets 3 are coupled to the at least one header through at least two second flow-changing means 8 for inducing non-laminar flow of exhaust gases through the at least one header 7. The at least one header 7 is coupled to the common exhaust stack 4 through at least one of the first-flow changing means 5 for inducing non-laminar flow of exhaust gases through the common exhaust stack 4. In this embodiment, at least some of the exhaust gas outlets 3 are connected to the header 7 through second flow-changing means 8. In another embodiment, at least some of the exhaust gas outlets 3 can be directly connected to the header 7. The flow of exhaust gases through the exhaust gas outlets 3 connected to the header 7 through the second flow-changing means 8 are more significantly induced to be non-laminar as compared to those directly connected to the header 7. In one embodiment, each second flow-changing means 8 is connected at an angle to the at least one header 7.

In one embodiment, as illustrated in FIG. 5A, the second flow-changing means 8 is implemented by connecting a second set of exhaust gas outlet connectors or interconnects 9 at an angle to the header 7. The exhaust gas outlets 3 are connected or coupled to the header 7 through the angled connectors 9 and form an angled connection with the header 7. The angled connection causes the gases flowing into the header 7 through the exhaust gas outlets 3 to rotate thereby changing the flow pattern of the exhaust gases to a non-laminar flow pattern. Rotational flow of the exhaust gases through the header 7 helps in minimizing the formation of cool spots in the header 7 and consequently condensates in the header 7.

In greater detail, exhaust system 1 shown in FIG. 5A, comprises three headers 7. One header 7 is shown having ten exhaust gas outlets 3 feeding into the header 7. Five exhaust gas outlets 3 are positioned on each of both sides of the header 7. The other two headers 7 are each coupled to five exhaust outlets 3 positioned on one side of the header 7.

In one embodiment, inducement of non-laminar flow of exhaust gases in an exhaust system 1 comprising three or more headers 7 can be further enhanced by vertically offsetting each of the three or more headers 7 from one another along the common exhaust stack 4.

With reference to FIG. 5B, inducement of non-laminar flow of exhaust gases through the header 7 can be further enhanced by arranging the exhaust gas outlets 3 on the header 7 in a particular arrangement. In this arrangement, centerlines of at least two exhaust outlets 3 positioned on opposing sides of a header 7 are offset from each other. Also, the at least two exhaust gas outlets 3 are connected generally tangentially to the header 7. This causes swirling of the exhaust gases resulting in enhanced non-laminar flow of exhaust gases through the header 7.

In one embodiment, non-laminar flow comprises turbulent flow of exhaust gases. Each of the first flow-changing means 5 induces turbulent flow of exhaust gases.

In another embodiment, as shown in FIGS. 2 and 5B, non-laminar flow comprises exhaust gases flowing in a generally helical path through the common exhaust stack 4 and the header 7. Each of the first flow-changing means 5 and the second flow-changing means 8 induces the exhaust gases to flow in a helical path through the common exhaust stack 4 and the header 7.

Inducement of non-laminar flow of the exhaust gases through the header 7 can be further enhanced by providing second elements (not shown) disposed at about the second flow-changing means 8. The second elements may be similar in construction to the first elements 6 described in detail with reference to FIG. 4. In one embodiment, the second element comprises a plurality of fins.

Non-laminar flow through the header 7 and the common exhaust stack 4 can be enhanced by offsetting the centerlines of the exhaust gas outlets 3 feeding into the header 7, vertically offsetting the headers 7 along the common exhaust stack 4, offsetting the centerlines of the headers 7 feeding in to the common exhaust stack 4 (similar to FIG. 2), providing local disturbances in the flow path of the exhaust gases in the header 7 and/or the common exhaust stack 4 or any combination of the various arrangements discussed in this paragraph.

Combining exhaust gases from a plurality of gas turbines 2 into a common exhaust stack 4 results in increased plume dispersion characteristics. Due to the presence of pollutants in the exhaust gases, constant efforts are being made to disperse the exhaust gases at higher altitudes. Attempts in the past have included increasing the height of the individual exhaust stack on each gas turbine. However, increasing the stack height is not a feasible solution. Increasing the stack height results in subjecting the exhaust stack to greater static and dynamic stresses as wind loading typically increases with altitude. Under such conditions, it may become difficult to keep the exhaust stack stable and this may result in overturning or buckling of the exhaust stack, which in turn may damage the gas turbine.

The arrangement of the exhaust gas outlets 3 or headers 7 about the circumference of the common exhaust stack 4 also renders the common exhaust stack design of the instant disclosure structurally robust. These factors allow construction of a taller exhaust stack without compromising its stability and durability during exposure to wind loading. Three arrangements for increasing structural rigidity of the exhaust system 1 are contemplated. In a first arrangement three or more gas turbines 2 are distributed circumferentially about the common exhaust stack 4 for providing structural rigidity to the exhaust system 1, such as under wind loading. Preferably, the three or more gas turbines 2 are evenly spaced about the circumference of the common exhaust stack 4. FIG. 1 illustrates one embodiment of the first arrangement. In FIG. 1, the exhaust system 1 comprises three, exhaust gas outlets 3, from three gas turbines 2, connected to the common exhaust stack 4 through three, first flow-changing means 5. The three, exhaust gas outlets 3 are distributed circumferentially about the common exhaust stack 4. Preferably, the three, exhaust gas outlets 3 are evenly spaced about the circumference of the common exhaust stack 4. This arrangement increases the stability of the exhaust system 1 under wind loading and provides better distribution of the mechanical load imparted by the wind. In a second arrangement, the exhaust system 1 comprises two headers 7. Each header 7 is coupled to at least two exhaust gas outlets 3 positioned on opposing sides of the header 7. Each header 7 is also coupled to the common exhaust stack 4. The two headers 7 are disposed on opposite sides of the common exhaust stack 4 in diametrically opposed relation to one another. This arrangement provides increased structural rigidity to the exhaust system 1 under wind loading. This arrangement may not be as structurally rigid when the wind direction is perpendicular to the common exhaust stack 4. A third arrangement contemplated by the Applicant comprises three or more headers 7 evenly spaced about the circumference of the common exhaust stack 4 for providing structural rigidity to the exhaust system 1 under wind loading. The third arrangement provides structural rigidity under any wind direction. In one embodiment of the third arrangement, illustrated in FIG. 5A, the exhaust system 1 comprises three headers 7. The three headers 7 are evenly distributed about the circumference of the common exhaust stack 4. This arrangement ensures better distribution of the mechanical load and makes the entire structure more stable irrespective of wind direction.

The headers 7 or exhaust gas outlets 3 around the common exhaust stack 4 act as reinforcing members and provide the additional strength and rigidity required for maintaining the common exhaust stack 4 stable under wind loading. Structural rigidity can optionally be further enhanced by providing individual support members 10 (FIG. 5A) located beneath the headers 7. A large footprint of the common exhaust stack 4 can also be mounted on a support pillar such as a piling (not shown) for increasing the structural rigidity of the exhaust system. Dispersion of exhaust gases is dominated by the effects of the buoyancy of the exhaust plume/exhaust gases since the exhaust gases are considerably hotter than the surrounding air it emerges into. Combining the thermal energy and velocity of exhaust gases from a plurality of exhaust gas outlets 3 as described in the foregoing paragraphs with reference to FIGS. 1 to 5B, increases the buoyancy of the exhaust gases flowing through the common exhaust stack 4. This ensures a higher minimum altitude for the exhaust gases dispersed through the common exhaust stack 4 as compared to exhaust gases dispersed through an individual exhaust stack. Coupling the exhaust gas outlets 3 to the common exhaust stack 4 increases volumetric flow of exhaust gases in the common exhaust stack 4 thereby increasing plume height of the exhaust gases.

As wind speed typically increases with altitude, greater dispersion of the exhaust gases through the common exhaust stack 4 is achieved. This helps in alleviating local concentration of odours and pollutants contained in the exhaust gases thereby minimising undesirable and potentially hazardous effects.

The following equations explain the relationship between buoyancy of the exhaust gases and plume rise:

Plume rise dynamics are described by Briggs' expression (1.1):

$$Δ h = \frac{1.6 {F}^{\frac{1}{3}} {x}^{\frac{2}{3}}}{\overline{u}} \qquad ( 1.1 )$$

### Where,

Δh is effective height of the plume centreline above the exhaust stack tip, in metres; ū is average wind speed, in metre/second;
x is the distance downwind of the plume, in meters;
F is buoyancy flux of the plume, in metre⁴ second³;

The buoyancy flux F is calculated as follows (1.2)

$$F = \frac{g}{π} V ( \frac{{T}_{stack} - {T}_{ambient}}{{T}_{stack}} ) \qquad ( 1.2 )$$

### Where,

g is the acceleration due to the gravity, in metre/sec²;
V is the volumetric flow rate of the stack gas, in kg/sec;
T_{stack} is the temperature of the exhaust gas, in ° C.;
T_{ambient} is the temperature of ambient air, in ° C.;

Buoyancy is independent of the diameter of the exhaust stack and is defined by the volumetric flow of gas through the exhaust stack and the gas temperature in exhaust stack. The elevated (compared to ambient) temperature of the exhaust gases ensures that the exhaust system is buoyancy dominated and the combination of exhaust gases from the plurality of gas turbines 3 increases the volumetric flow through the common exhaust stack 4 leaving other parameters unchanged. This increased flow has a cubed root impact on the plume height meaning that, for a cluster of twenty gas turbines, the plume height is increased by a factor of approximately 2.7 times.

Thus, for a given stack height, each gas turbine inputting to the common exhaust stack 4 can achieve satisfactory dispersion performance at a markedly lower operating volume flow rate than would be required if the exhaust stack were isolated. The common exhaust stack design thus allows the gas turbines to continue to meet air dispersion requirements even if one or more gas turbines 3 in the exhaust system are inactive or producing less.

### Example

An example illustrating the effectiveness of a common exhaust stack 4 is set out below:

For a flow of 34,000 m³/day with an H₂S content of 800 ppm it was found that, by increasing the exhaust stack height by 23% over that necessary to meet SO₂ air quality objectives, the H₂S handling capabilities of the exhaust stack were increased to over 2,000 ppm.

The common stack design system creates a simpler, more robust structure than would be achieved if each individual gas turbine was furnished with its own stack. Individual stacks tall enough to guarantee the same air dispersion performance as the common exhaust stack design would be considerably taller (assuming a fixed diameter) than the common exhaust stack and thus subject to greater static and dynamic stresses due to their increased exposure to higher winds. Since the common exhaust stack design combines multiple gas turbine exhausts into one, it is possible to design an exhaust stack that has a height-to-diameter ratio comparable to a small single gas turbine exhaust stack. The arrangement of the gas outlets/headers about the circumference of the common exhaust stack also renders the common exhaust stack design structurally robust. These factors allow construction of a taller exhaust stack without compromising its stability and durability during exposure to higher winds with high loading on the exhaust stack.

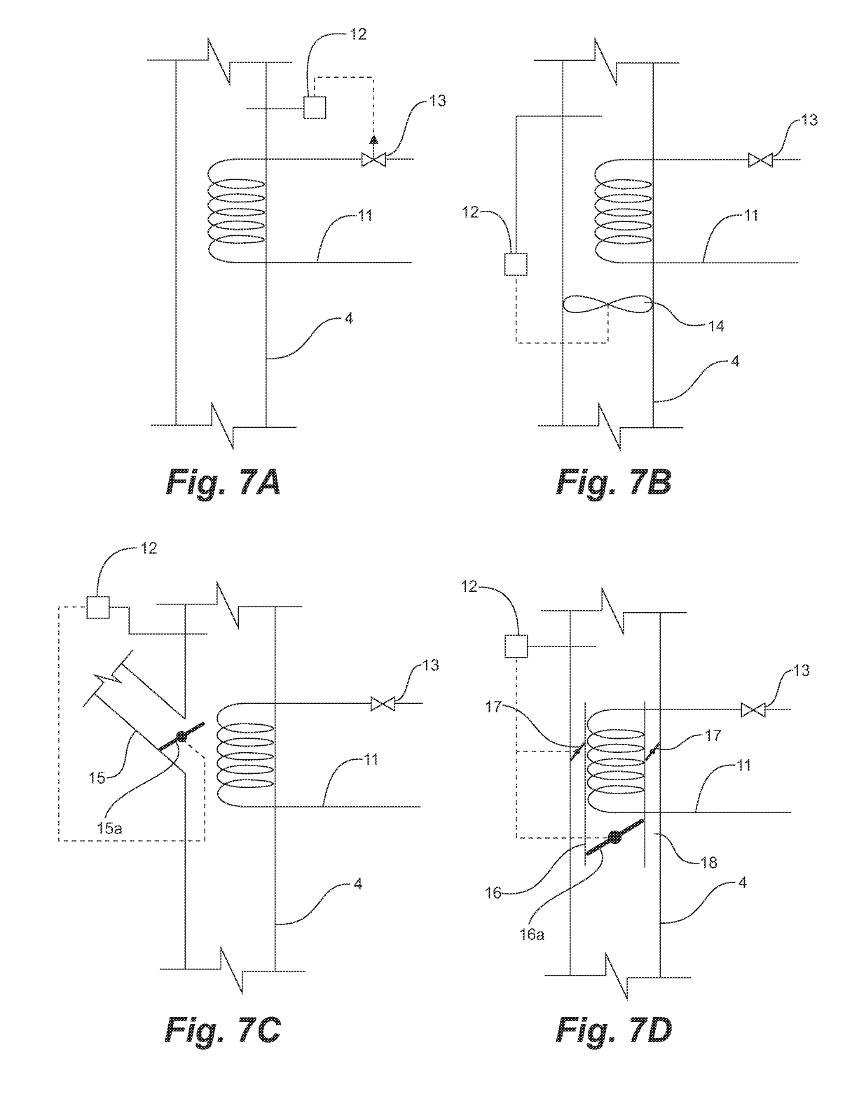

In one embodiment and with reference to FIG. 6, the exhaust system 1 is associated or operatively coupled with a heat exchanger 11 for recovery of heat from the exhaust gases. The recovered heat is recycled to drive other processes.

As described in the foregoing paragraphs, laminar flow of exhaust gases through a heat exchanger in a conventional exhaust system results in cool spots being formed along the heat transfer region and inefficient heat transfer.

Flow of the exhaust gases through the exhaust system 1 of the instant disclosure is non-laminar. Non-laminar flow results in uniformity of temperature in the working space. Working space includes the conduits/components through which the exhaust gases flow namely the headers 7, the common exhaust stack 4 and the heat exchanger 11. Non-laminar flow increases the velocity of the exhaust gas molecules. When the velocity increases, cooler molecules that have transferred energy to the surface are quickly replaced by higher temperature molecules, resulting in increased convective heat transfer. Further, non-laminar flow also minimizes the fluctuations in the temperature in the working space due to one or more inactive gas turbines 3 or when throughput from the gas turbines is not equal.

Applicant has identified that in order to significantly minimize condensate formation in the common exhaust stack 4, temperature of the exhaust gases flowing out of the heat exchanger 11 must be maintained above a certain threshold dew point. Selection of the threshold dew point depends on the composition of the exhaust gases and particular concentrations of the compounds therein. For exhaust gases generated from the burning of natural gas, the threshold dew point must be maintained between about 100° C. and about 200° C., preferably above about 150° C. One method for determining the threshold dew point is to couple a gas analyser/chromatographer (not shown) to the fuel gases to the gas turbines 2. The gas analyser continuously measures the moisture and/or acid gas content in the exhaust gases and determines a threshold dew point. Maintaining the temperature in the common exhaust stack 4 above the threshold dew point enables the exhaust gases to exit the common exhaust stack 4 without condensation. It will be understood that the determined threshold dew point will change depending on the composition of the exhaust gases and will vary during an operation cycle of the exhaust system 1.

Temperature of the exhaust gases flowing through the common exhaust stack 4 can be affected by a number of parameters—variable flow rate of exhaust gases from the gas turbines 3 for the reasons identified above, a large proportion of exhaust gases being diverted to the heat exchanger 11 for recovery of heat. In order to optimize the exhaust system 1, for recovering the available energy and the avoidance of dew point issues in the common exhaust stack 4, in one embodiment and with reference to FIG. 6, an automated controller 12 is provided in the common exhaust stack 4. The heat exchanger 11, in this embodiment, is located in the common exhaust stack 4 and is operatively coupled to the automated controller 12 for maintaining temperature at the heat exchanger 11 above the threshold dew point to prevent condensate formation in the exhaust system 1. The automated controller 12 continuously monitors the temperature in the common exhaust stack 4 and reduces heat recovery from the exhaust gases flowing through the heat exchanger 11 when the temperature in the common exhaust stack 4 approaches the threshold dew point.

The automated controller 12 may be a microcontroller or other logic-based control system comprising sensors (not shown) for measuring temperature. Because the temperature in the common stack 4 is significantly uniform because of the non-laminar flow, it is possible to sense the temperature at the sidewall of the common exhaust stack 4. A less sophisticated sensor can, therefore, be used to sense the temperature. This results in significant cost savings.

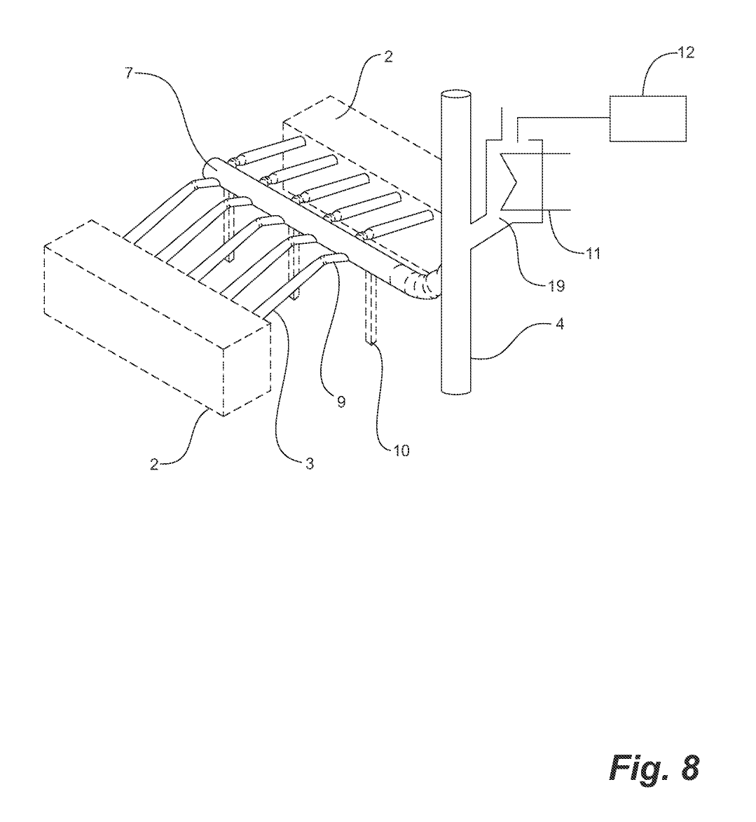

In one embodiment and with reference to FIG. 7A, reduction in heat extraction or recovery is achieved by increasing the dwell time of the working fluid in the heat pipes of the heat exchanger 9. The automated controller 12 is operatively connected to a working fluid pump 13 for changing the flow rate of the working fluid flowing through the heat pipes when the temperature in the common exhaust stack 4 approaches the threshold dew point.

In another embodiment and with reference to FIG. 7B, reduction in heat extraction is achieved by decreasing the residence time of the exhaust gases in the heat exchanger 11. The residence time of the exhaust gases is decreased by providing a fan or blower 14 in the heat exchanger 11. The automated controller 12 is operatively connected to the fan 14. The automated controller 12 continuously senses the temperature and as the temperature in the common exhaust stack 4 approaches the threshold dew point, the automated controller 12 activates the fan 14 for accelerating flow of the exhaust gases through the heat exchanger 11.

In yet another embodiment and with reference to FIG. 7C, the common exhaust stack 4 is provided with a bypass passage 15. Access to the bypass passage 15 is controlled by a butterfly valve 15a. The butterfly valve 15a is operatively coupled to the automated controller 12. The automated controller 12 continuously monitors the temperature in the common exhaust stack 4 and controls opening and closing of the bypass passage 15 through the butterfly valve 15a in response to the temperature in the common exhaust stack 4. If the temperature in the common exhaust stack 4 approaches the threshold dew point, the automated controller 12 opens the butterfly valve 15a thereby allowing passage of exhaust gases through the bypass passage 15 for regulating temperature in the common exhaust stack 4.

In another embodiment and with reference to FIG. 7D, the heat exchanger 11 is located in a housing 16 disposed in the common exhaust stack 4. The automated controller 12 controls flow of exhaust gases through the housing 16 through a bypass valve 16a and valves 17, 17 in response to the temperature in the common exhaust stack 4. Valves 17, 17 are located in an annulus 18 formed between an external surface of the housing 16 and the sidewall of the common exhaust stack 4. When the temperature in the exhaust stack is above the threshold dew point, the automated controller opens the bypass valve 16a and closes the valves 17,17 thereby allowing passage of exhaust gases through the housing 16 for recovery of heat. If the temperature in the common exhaust stack 4 approaches the threshold dew point, the automated controller 12 closes the bypass valve 16a and opens the valves 17, 17 for allowing passage of exhaust gases through the annulus 18. The exhaust gases flow through the common exhaust stack 4 circumventing the heat exchanger 11.

Temperature regulation in the common exhaust stack 4 can be achieved either by changing the flow rate of the working fluid or by decreasing the residence time of the exhaust gases through the heat exchanger 11 or by providing a bypass passage 15 or by controlling access to a housing locating the heat exchanger or any combination of the alternatives stated above.

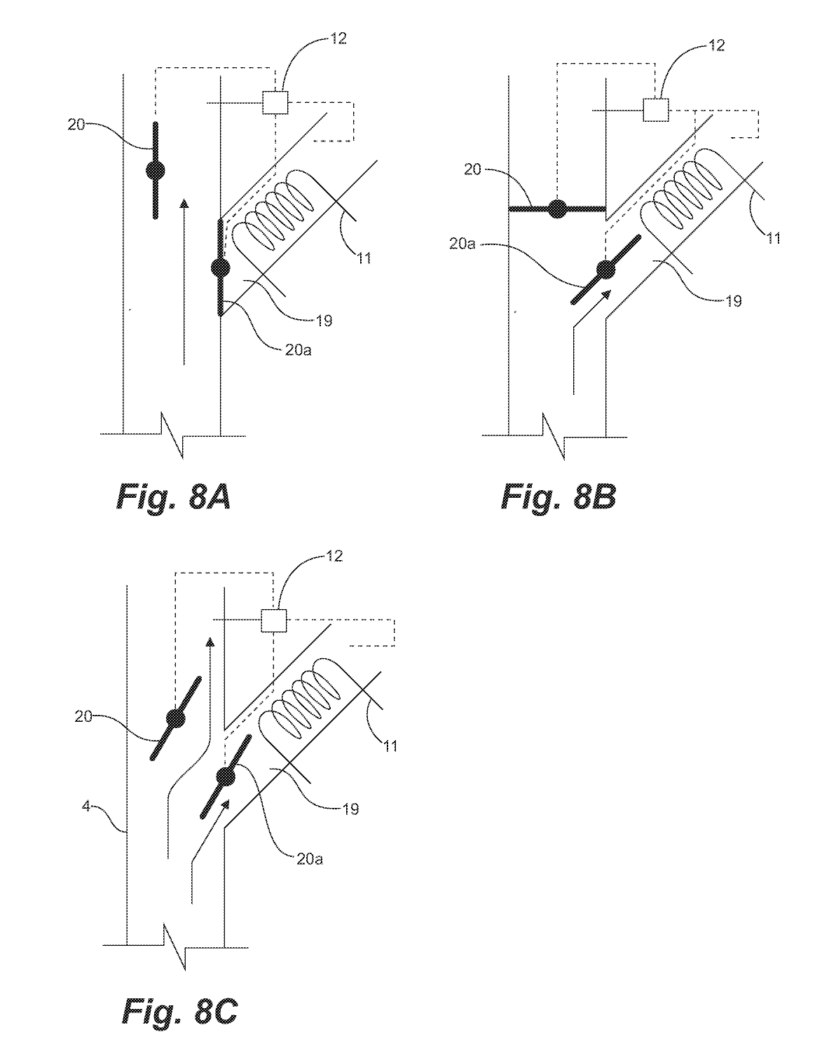

In one embodiment and with reference to FIG. 8, the heat exchanger 11 is located in a heat exchanger conduit 19 arranged in a parallel configuration with the common exhaust stack 4. In order to minimize condensate formation in the common exhaust stack 4 and the heat exchanger conduit 19, temperature in the heat exchanger conduit 19 is continuously monitored by the automated controller 12. As the temperature in the heat exchanger conduit 19 approaches the threshold dew point, flow of exhaust gases through the common exhaust stack 4 and the heat exchanger conduit 19 is controlled or regulated. The Applicant has contemplated various arrangements for controlling or regulating flow of exhaust gases through the common exhaust stack 4 and the heat exchanger conduit 19.

In one arrangement and with reference to FIGS. 8A-8C, the automated controller 12 is operatively coupled to valves 20 and 20a located in the common exhaust stack 4 and the heat exchanger conduit 19, respectively. The automated controller 12 continuously monitors the temperature in the heat exchanger conduit 19 and if the temperature approaches the threshold dew point, the valve 20a in the heat exchanger conduit is closed and the valve 20 in the common exhaust stack 4 is opened and the exhaust gases are allowed to flow through the common exhaust stack 4 (FIG. 8A). When the temperature is generously above the threshold dew point, the valve 20 in the common exhaust stack 4 remains closed and all the exhaust gases are allowed to flow, or otherwise directed, through the heat exchanger conduit 19 through the open valve 20a (FIG. 8B). If the temperature is above the threshold dew point, flow of exhaust gases is diverted through the common exhaust stack 4 and the heat exchanger conduit 19 through the open valves 20 and 20a until one of the above mentioned states occurs (FIG. 8C). “Generously above” means an instance where recovery of heat from the exhaust gases will not cause the temperature at the heat exchanger conduit 19 to tend towards the threshold dew point.

Heat recovery can be further enhanced by allowing a controlled amount of condensate to form in the common exhaust stack 4 or heat exchanger conduit 16. The amount is based on an evaluation of additional power production versus increased maintenance and repair cost of the exhaust system associated with the condensate formation. Calculation of the threshold dew point (discharge temperature) for formation of the controlled amount of condensate may be based on prior operating history (integrated condensate level estimate) to determine the degree of acceptable degradation in the exhaust materials and thus define a value-based optimal flue gas discharge temperature. Based on this recorded data a prediction model can be developed for real time regulation of flow of exhaust gases through the common exhaust stack 4 and the heat exchanger conduit 16. This involves adapting the automated controller 12 to receive input from a gas analyser, flow velocity sensors, temperature sensors and pressure sensors. The temperature sensors, pressure sensors, flow velocity sensors and the gas analyser are located onto the common pipeline that leads the solution gas to the gas turbine inlets. The automated controller 12 receives input from the various sensors, processes the input and generates an output for regulating flow of exhaust gases. The gas analyser provides measurements of the moisture and acid gas content in the exhaust gases, for example H₂S, and time tags this data before transmission to the automated controller 12 paired with the corresponding flow velocity data. The automated controller 12 will use this data to calculate when each time packet will arrive at the common exhaust stack 4 and will be able to use the current temperature data in the common exhaust stack 4 to predict a threshold dew point and estimate whether the present heat recovery will cause the temperature to drop below the predicted threshold dew point.

Equations for predicting the threshold dew point are known and are as follows:

Dew points, in ° C., of the gasses SO3, SO2, HCl and NO2 can be calculated by means of the equations of Verhoff, Perry, and Kiang (W. M. M. Huijbregts, R. G. I. Leferink, “Latest advances in the understanding of acid dewpoint corrosion: corrosion and stress corrosion cracking in combustion gas condensates”, Anti-corrosion Methods and Materials, 51 (3):173-178, 2004):

A: Dew point equation of SO₃ according to Verhoff:

$${T}_{d} = \frac{1000}{\{ \begin{matrix}2.276 - 0.02948 * ln ( {P}_{H 2 O} ) - \\ 0.0858 * ln ( {P}_{SO 3} ) + 0.0062 * ln ( {P}_{H 2 O} * {P}_{SO 3} )\end{matrix} \}}$$

B: Dew point equation of SO₂ according to Kiang:

$${T}_{d} = \frac{1000}{\{ \begin{matrix}3.9526 - 0.1863 * ln ( {P}_{H 2 O} ) - 0.000867 * \\ ln ( {P}_{SO 2} ) + 0.00091 * ln ( {P}_{H 2 O} * {P}_{SO 2} )\end{matrix} \}}$$

C: Dew point equation of HCl according to Kiang:

$${T}_{d} = \frac{1000}{\{ \begin{matrix}3.7368 - 0.1591 * ln ( {P}_{H 2 O} ) - 0.0326 * \\ ln ( {P}_{HCl} ) + 0.00269 * ln ( {P}_{H 2 O} * {P}_{HCl} )\end{matrix} \}}$$

D: Dew point equation of NO₂ according to Perry:

$${T}_{d} = \frac{1000}{( \begin{matrix}\begin{matrix}3.664 - 0.1446 * ln ( \frac{v \% {H}_{2} O}{100 * 760} ) - \\ 0.0827 * ln ( \frac{{vppm NO}_{2}}{1000000 * 760} ) +\end{matrix} \\ 0.00756 * ln ( \frac{v \% {H}_{2} O}{100 * 760} ) ln ( \frac{{vppm NO}_{2}}{1000000 * 760} )\end{matrix} ) - 273}$$

### Where,

Pₓ—is partial pressure, in atmospheres (equation A) and in mmHg (equation B, C, D), where the subscript x refers to the component of interest;
T_{d}—is the acid dew point temperature for each particular acid, in Kelvins;

Compared with published measured data, the acid dew points predicted with equations A, B, C, D are said to be within 9° C. of the published measured data. When the temperature starts approaching the predicted threshold dew point, the system needs to reduce the heat transfer from the exhaust gases to the heat recovery fluid. This can be achieved by the arrangements illustrated in FIGS. 7A-7D and FIGS. 8A-8C. This minimizes the risk of condensate forming on the surfaces of the heat exchanger 11, and optimising recovery of the available energy.

The exhaust system 1 may comprise back-flow dampers (not shown) and isolation dampers (not shown) for preventing exhaust from an operating gas turbine from entering a non-operating gas turbine. US Patent Application Publication No. 2012/0180485 to Smith et al. teaches implementation of such dampers.

The exhaust system 1 may also comprise a drain (not shown) for draining any fluid that may be present in the exhaust gas outlets 3. The drain is typically positioned adjacent to the isolation damper.

The embodiments of the invention for which an exclusive property or privilege is claimed are defined as follows:

1. An exhaust system for a plurality of gas turbines comprising:
a common exhaust stack disposed in a generally vertical arrangement; and
an exhaust gas outlet positioned on each of the plurality of gas turbines; wherein
the exhaust gas outlet of each of the plurality of gas turbines is coupled to the common exhaust stack through a respective first flow-changing means for inducing non-laminar flow of exhaust gases through the common exhaust stack.

2. The exhaust system of claim 1 wherein each of the first flow-changing means is connected at an angle to the common exhaust stack.

3. The exhaust system of claim 1 wherein each of the first flow-changing means is offset vertically along the common exhaust stack.

4. The exhaust system of claim 1 wherein each of the first flow-changing means is connected generally tangentially to the common exhaust stack.

5. The exhaust system of claim 1 wherein each of the first flow-changing means comprises first elements disposed thereabout.

6. The exhaust system of claim 5 wherein the first elements comprises a plurality of fins.

7. The exhaust system of claim 1 wherein each of the first flow-changing means induces turbulent flow of exhaust gases.

8. The exhaust system of claim 1 wherein each of the first flow-changing means induces the exhaust gases to flow in a helical path through the common exhaust stack.

9. The exhaust system of claim 1 wherein the system comprises three or more gas turbines and wherein the three or more gas turbines are distributed circumferentially about the common exhaust stack for providing structural rigidity to the exhaust system under wind loading.

10. The exhaust system of claim 5 wherein the three or more gas turbines are evenly spaced about the circumference of the common exhaust stack.

11. The exhaust system of claim 1 further comprising at least one header and wherein at least two exhaust gas outlets are coupled to the at least one header through at least two second flow-changing means for inducing non-laminar flow of exhaust gases through the at least one header.

12. The exhaust system of claim 11 wherein each second flow-changing means is connected at an angle to the at least one header.

13. The exhaust system of claim 11 wherein the at least one header is coupled to the common exhaust stack through at least one of the first flow-changing means.

14. The exhaust system of claim 11 wherein the system comprises two headers and wherein the at least two exhaust gas outlets are positioned on opposing sides of each header for providing structural rigidity to the exhaust system under wind loading.

15. The exhaust system of claim 11 wherein the system comprises three or more headers and wherein the three or more headers are evenly spaced about the circumference of the common exhaust stack for providing structural rigidity to the exhaust system under wind loading.

16. The exhaust system of claim 15 wherein each of the three or more headers are offset vertically from one another along the common exhaust stack.

17. The exhaust system of claim 14 wherein the at least two exhaust outlets positioned on opposing sides of each header are connected generally tangentially to each header.

18. The exhaust system of claim 11 wherein each of the at least two second flow-changing means comprises second elements disposed thereabout for enhancing non-laminar flow of exhaust gases through the at least one header.

19. The exhaust system of claim 18 wherein the second elements comprises a plurality of fins.

20. The exhaust system of claim 1 wherein the exhaust gas outlets being coupled to the common exhaust stack increases volumetric flow of exhaust gases in the common exhaust stack thereby increasing plume height of the exhaust gases.

21. The exhaust system of claim 1 further comprising a heat exchanger operatively coupled to the common exhaust stack for recovery of heat from the exhaust gases flowing through the common exhaust stack.

22. The exhaust system of claim 21 wherein the heat exchanger is operatively coupled to an automated controller for maintaining temperature at the heat exchanger above a threshold dew point to prevent condensate formation in the exhaust system.

23. The exhaust system of claim 22 wherein the heat exchanger is located in the common exhaust stack.

24. The exhaust system of claim 23 wherein the automated controller continuously monitors the temperature in the common exhaust stack and reduces recovery of heat from the exhaust gases flowing through the heat exchanger when the temperature approaches the threshold dew point.

25. The exhaust system of claim 24 wherein reduction in heat recovery is achieved by increasing residence/dwell time of working fluid in the heat exchanger.

26. The exhaust system of claim 24 wherein reduction in heat recovery is achieved by decreasing residence time of exhaust gases in the heat exchanger.

27. The exhaust system of claim 26 wherein residence time of exhaust gases in the heat exchanger is decreased by accelerating flow of the exhaust gases through the heat exchanger.

28. The exhaust system of claim 23 wherein the common exhaust stack comprises a bypass passage and the automated controller controls opening and closing of the bypass passage in response to the temperature in the common exhaust stack.

29. The exhaust system of claim 23 wherein the heat exchanger is located in a housing disposed in the common exhaust stack and the automated controller controls flow of exhaust gases through the housing in response to the temperature in the common exhaust stack.

30. The exhaust system of claim 21 wherein the heat exchanger is located in a heat exchanger conduit arranged in a parallel configuration with the common exhaust stack.

31. The exhaust system of claim 30 wherein heat exchanger is operatively coupled to an automated controller which continuously monitors the temperature in the heat exchanger conduit and controls flow of exhaust gases through the heat exchanger conduit when the temperature in the heat exchanger conduit approaches the threshold dew point.

32. The exhaust system of claim 30 further comprising valves located in the common exhaust stack and the heat exchanger conduit, the automated controller being operatively coupled to the valves for allowing or preventing passage of exhaust gases through the common exhaust stack and the heat exchanger conduit in response to the temperature in the heat exchanger conduit.

33. A method of recovering heat from exhaust gases flowing through a common exhaust stack receiving exhaust gases from a plurality of gas turbines connected thereto, the method comprising:
locating a heat exchanger in the common exhaust stack;
inducing non-laminar flow of exhaust gases through the common exhaust stack and the heat exchanger for minimizing formation of cool spots along a heat transfer interface;
determining a threshold dew point for exit of exhaust gases through the common exhaust stack;
directing the exhaust gases through the heat exchanger for recovery of heat from the exhaust gases along the heat transfer interface;
continuously monitoring the temperature at the heat exchanger; and
reducing heat recovery from the exhaust gases flowing through the heat exchanger when the temperature at the heat exchanger approaches the threshold dew point.

34. The method of claim 33 wherein the step of determining a threshold dew point further comprises continuously determining the threshold dew point during an operation cycle.

35. A method of recovering heat from exhaust gases flowing through a common exhaust stack receiving exhaust gases from a plurality of gas turbines connected thereto, the method comprising:
locating a heat exchanger in a heat exchanger conduit, the heat exchanger conduit arranged in a parallel arrangement with the common exhaust stack;
inducing non-laminar flow of exhaust gases through the common exhaust stack and the heat exchanger conduit for minimizing formation of cool spots along a heat transfer interface;
determining a threshold dew point for exit of exhaust gases through the common exhaust stack and/or the heat exchanger conduit;
directing the exhaust gases through the heat exchanger conduit for recovery of heat from the exhaust gases along the heat transfer interface;
continuously monitoring the temperature at the heat exchanger conduit; and
controlling flow of the exhaust gases through the common exhaust stack and the heat exchanger conduit in response to the temperature at the heat exchanger conduit.

36. The method of claim 34 wherein the step of controlling flow of the exhaust gases through the common exhaust stack and the heat exchanger conduit further comprises:
opening an access to the heat exchanger conduit when the temperature at the heat exchanger conduit is generously above the threshold dew point for passage of exhaust gases therethrough;
opening an access to the common exhaust stack and maintaining the access to the heat exchanger conduit open when the temperature at the heat exchanger conduit is above the threshold dew point; and
closing the access to the heat exchanger conduit and maintaining the access to the common exhaust stack open when the temperature at the heat exchanger conduit approaches the threshold dew point.
